(19) United States
(12) Patent Application Publication
(10) Pub. No.: US 2017/0147675 A1
(43) Pub. Date: May 25, 2017

(54) HIGH DIMENSIONAL CLUSTERS PROFILE GENERATION

(71) Applicant: International Business Machines Corporation, Armonk, NY (US)

(72) Inventors: Sier Han, Xian (CN); Zhiyuan Wang, Xian (CN); Ji Hui Yang, Xian (CN); A Peng Zhang, Xian (CN); Xueying Zhang, Xian (CN); Xiu Fang Zhu, Beijing (CN)

(21) Appl. No.: 14/945,853

(22) Filed: Nov. 19, 2015

(51) Int. Cl. G06F 17/30

(52) U.S. Cl. CPC G06F 17/30598

(57) ABSTRACT

Refining cluster definition: (i) receiving data items, each characterized by values respectively corresponding to a set of dimension(s); (ii) receiving initial cluster identification that divides the set of data items into multiple initial clusters; (iii) determining a distribution curve, with respect to a first dimension, of data items of a first initial cluster; (iv) determining a distribution curve, with respect to the first dimension, of data items of a second initial cluster; and (v) determining a first-dimension-first-cluster-second-cluster cut-off value such that the following two proportions are substantially equal: (a) a proportion of the area under the first distribution curve and below the first-dimension-first-cluster-second-cluster cut-off value to the total area under the first distribution curve, and (b) a proportion of the area under the second distribution curve and above the first-dimension-first-cluster-second-cluster cut-off value to the total area under the second distribution curve.

### BACKGROUND

The present invention relates generally to the field of data analytics and more particularly to efficiently characterizing large quantities of machine readable, multidimensional data.

With the development of information technology and the internet, “big data” and the quantity of high dimensional data (data with a large number of attributes), such as multi-media data and gene microarray data, on the internet is growing exponentially. Data attributes (dimensions) can number in the hundreds. Two aspects of high dimensional data analysis are: (i) high dimensional data clustering techniques; and (ii) extraction of insights that result from clustering (called “cluster profile generation”). Some conventional data mining applications require descriptions that can be easily assimilated by a user as insights.

The “cluster analysis” entry of Wikipedia states (as of Oct. 7, 2015) as follows: “Cluster analysis or clustering is the task of grouping a set of objects in such a way that objects in the same group (called a cluster) are more similar (in some sense or another) to each other than to those in other groups (clusters). It is a main task of exploratory data mining, and a common technique for statistical data analysis, used in many fields, including machine learning, pattern recognition, image analysis, information retrieval, and bioinformatics. Cluster analysis itself is not one specific algorithm, but the general task to be solved. It can be achieved by various algorithms that differ significantly in their notion of what constitutes a cluster and how to efficiently find them.”

### SUMMARY

According to an aspect of the present invention, there is a method, computer program product and/or system that performs the following operations (not necessarily in the following order): (i) receiving a set of data items, where each data item is characterized by a set of scalar values respectively corresponding to a set of dimension(s) including a first dimension; (ii) receiving an identification of a set of initial clusters that divide the set of data items into a plurality of initial clusters including a first cluster and a second cluster; (iii) determining a first distribution curve, with respect to the first dimension, for the scalar values corresponding to the first dimension of the data items of the first initial cluster; (iv) determining a second distribution curve, with respect to the first dimension, for the scalar values corresponding to the first dimension of the data items of the second initial cluster; and (v) determining a first-dimension-first-cluster-second-cluster cut-off value such that the following two proportions are at least substantially equal: (a) a proportion of the area under the first distribution curve and below the first-dimension-first-cluster-second-cluster cut-off value to the total area under the first distribution curve, and (b) a proportion of the area under the second distribution curve and above the first-dimension-first-cluster-second-cluster cut-off value to the total area under the second distribution curve.

### BRIEF DESCRIPTION OF THE DRAWINGS

FIG. 1 is a block diagram of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a flowchart of a second embodiment of a method according to the present invention;

FIG. 5A is a flowchart of a third embodiment of a method according to the present invention;

FIG. 5B is a screenshot view showing information that is generated by the fourth embodiment method;

FIG. 6A is a graph showing information that is helpful in understanding embodiments of the present invention;

FIG. 6B is a graph showing information that is helpful in understanding embodiments of the present invention;

FIG. 7A is a graph showing information that is helpful in understanding embodiments of the present invention; and

FIG. 7B is a table showing information that is helpful in understanding embodiments of the present invention.

### DETAILED DESCRIPTION

Some embodiments of the present invention are directed to techniques for refining cluster definition by machine logic including: (i) receiving a set of data items, where each data item is characterized by a set of dimension(s) including a first dimension, with the first dimension for each data item being expressed as a number; (ii) receiving an identification of a set of initial clusters that divide the set of data items into a plurality of initial clusters including a first cluster and a second cluster; (iii) determining a first distribution curve, with respect to the first dimension, for the data items of the first initial cluster; (iv) determining a second distribution curve, with respect to the first dimension, for the data items of the second initial cluster; and (v) determining a first-dimension-first-cluster-second-cluster cut-off value such that the following two proportions are at least substantially equal: (a) a proportion of the area under the first distribution curve and below the first-dimension-first-cluster-second-cluster cut-off value to the total area under the first distribution curve, and (b) a proportion of the area under the second distribution curve and above the first-dimension-first-cluster-second-cluster cut-off value to the total area under the second distribution curve.

Some embodiments of the present disclosure are directed to a method where: (i) from a set of multi-dimensional data that has been divided into clusters, a sub-set of the most “important” dimensions is selected based on an “F-test” (that is, by treating cluster labels as values of a pseudo target; (ii) a set of rules (called “cut point rules”) are determined, with the rules being operative to split two clusters along a dimension; (iii) the rules for each cluster will be obtained by combining the rules that can split the cluster from other clusters; and (iv) final clusters will be obtained based on the rules of each cluster. The cut points in the operation (iii) will be computed only based on basic statistics that output from operation (i). The basic statistics include: cluster size (number of records in the cluster), cluster center (mean of each dimension in the cluster), and cluster variance (variance of each dimension in the cluster).

This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

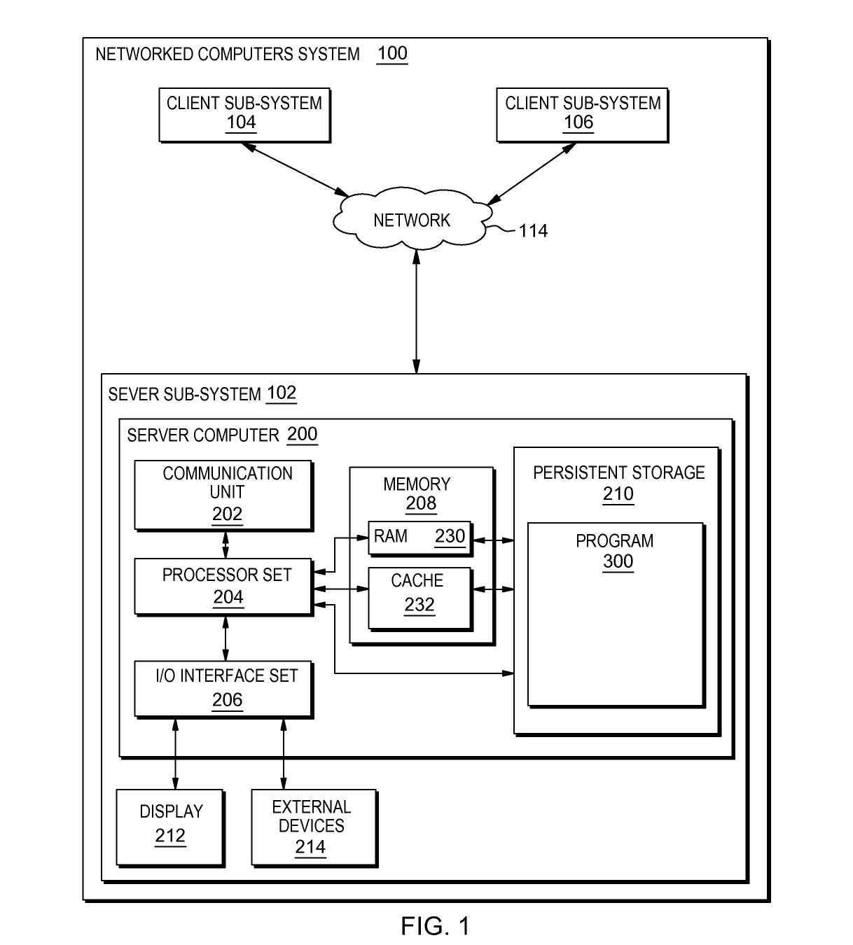

An embodiment of a possible hardware and software environment for software and/or methods according to the present invention will now be described in detail with reference to the Figures. FIG. 1 is a functional block diagram illustrating various portions of networked computers system 100, including: server sub-system 102; client sub-systems 104, 106; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300.

Database server sub-system 102 is, in many respects, representative of the various computer sub-system(s) in the present invention. Accordingly, several portions of sub-system 102 will now be discussed in the following paragraphs.

Database server sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Database server sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Database server sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for database server sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to database server sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

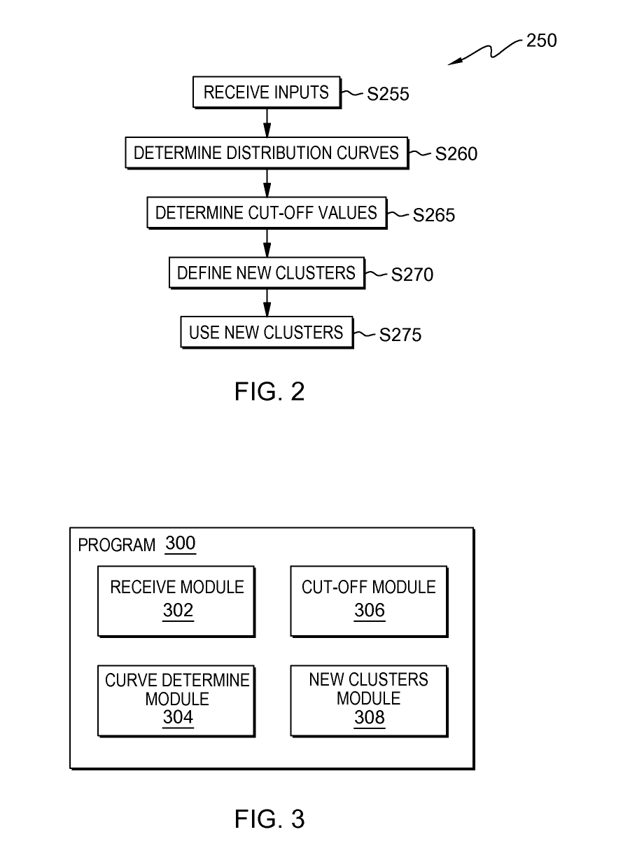

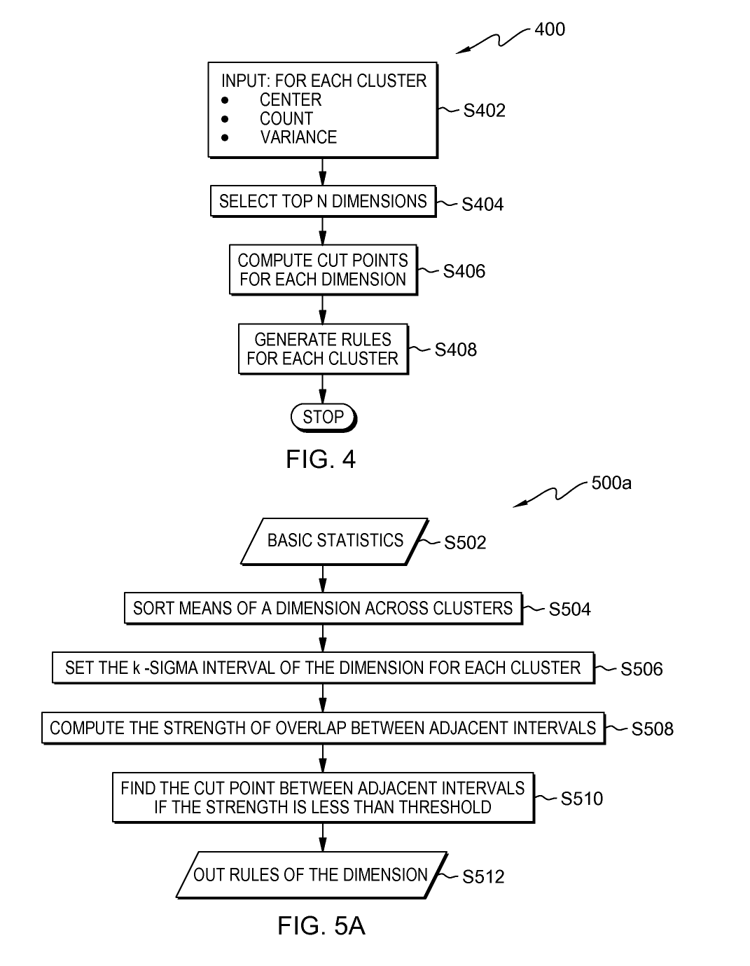

FIG. 2 shows flowchart 250 depicting a method according to the present invention. FIG. 3 shows program 300 for performing at least some of the method operations of flowchart 250. This method and associated software will now be discussed, over the course of the following paragraphs, with extensive reference to FIG. 2 (for the method operation blocks) and FIG. 3 (for the software blocks).

Processing begins at operation S255, where receive module (“mod”) 302 receives: (i) a set of data items, where each data item is characterized by a set of dimensions, with each dimension for each data item being expressed as a number; and (ii) an identification of a set of initial clusters that specifies how to divide the set of data items into a set of initial clusters.

Processing proceeds to operation S260, where curve determination mod 304 determines, for each cluster and with respect to each dimension of the set of dimensions, a respectively corresponding distribution curve. In this example, the data items each have five (5) dimensions and there are seven (7) clusters, so, consequently, thirty-five (35) distribution curves are determined at operation S260. In this example, all of the thirty-five distribution curves are bell curves respectively characterized by a standard deviation value. Alternatively, clusters may have different types of distribution curves characterized by different types of variance value(s) (now known or to be developed in the future).

Processing proceeds to operation S265, where cut-off mod 306 determines, for each successive pair of adjacent clusters with respect to each dimension, a cut-off value. For a given dimension, the successive pairs are determined based on the mean values for each cluster, with the mean value, for a given dimension, of an initial cluster being the mean value determined from the scalar values corresponding to the given dimension of the initial cluster. The cut-off value for a given cluster pair (called A and B for convenient reference) and with respect to a given dimension, is determined so that the following two proportions are at least substantially equal: (i) a proportion of the area under the distribution curve (for cluster A and with respect to the given dimension) and below the cut-off value to the total area under the distribution curve (for cluster A and with respect to the given dimension); and (ii) a proportion of the area under the distribution curve (for cluster B and with respect to the given dimension) and above the cut-off value to the total area under the distribution curve (for cluster B and with respect to the given dimension). In this embodiment all of the cut-off values are calculated. Alternatively, only a sub-set of the cut-off values may be calculated. For example, cut-off values may be calculated only for cluster pairs and dimensions where the cluster pairs have overlapping data items or, at least, data items in close proximity as determined by the set of initial clusters.

Processing proceeds to operation S270, where new cluster mod 308 defines a set of new clusters based on the cut-off values determined at operation S265.

Processing proceeds to operation S275, where the set of new clusters is used to perform an action that: (i) is implemented by a particular machine in a non-conventional and non-trivial manner, and/or (ii) transforms an article from one state to another. For example, the identification of the new clusters may be sent through network 114 to client sub-system 104 (see FIG. 1), where the new clusters are used to control an industrial manufacturing process performed by a machine particular to that industrial manufacturing process.

### III. Further Comments and/or Embodiments

Some embodiments of the present invention recognize the following facts, potential problems and/or potential areas for improvement with respect to the current state of the art: (i) in conventional cluster analysis, data are divided into several clusters in such a way that data in a cluster are more similar to each other than to data in other clusters; (ii) only central vectors are given to represent clusters; (iii) distance to each cluster is computed to determine to which cluster a new data point belongs; (iv) users do not know what the characteristics of a cluster are, especially, when there are a large number of dimensions; and/or (v) it is difficult to know to which cluster a new data point belongs without computing distances.

Some embodiments of the present invention may include one, or more, of the following features, characteristics and/or advantages: (i) provide insights as to which dimension(s) play relatively more important roles than others in characterizing a given cluster; (ii) provide insights on boundaries between clusters; (iii) provide insights on data distribution within each cluster; (iv) provide predetermined thresholds on key dimensions for each cluster; requires only limited statistics from the clusters; (v) work with existing clustering algorithms; (vi) provide less complex rules relative to some conventional methods; (vii) generate high dimensional cluster profiles based on limited basic cluster statistics without additional data passes. Note: “high dimensional” pertains to data that has a large number of attributes (dimensions).

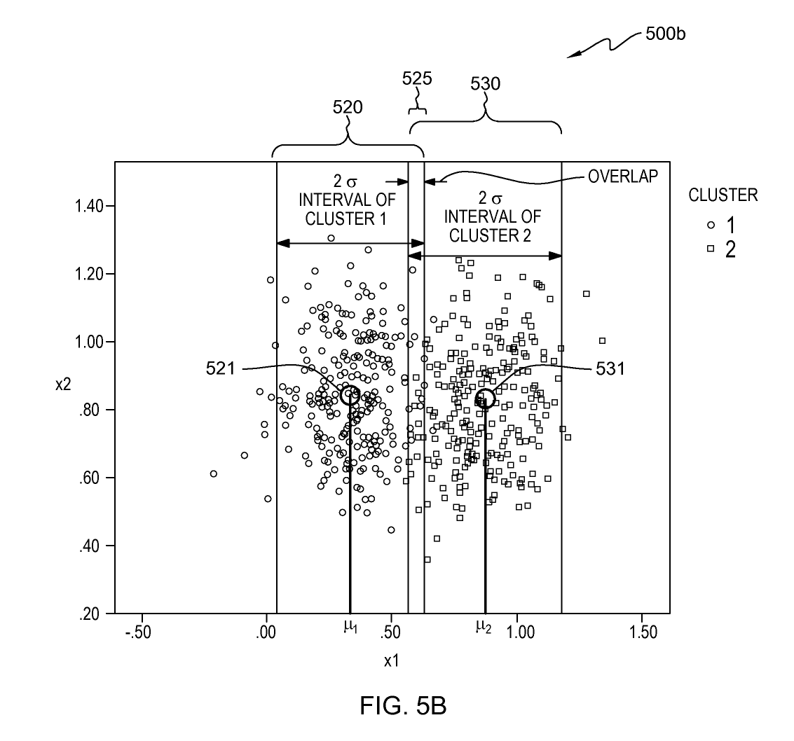

FIG. 4 shows flowchart 400 depicting a method according to the present invention. Processing begins with operation S402 where, for each cluster, statistics are collected including: (i) cluster center coordinates in all dimensions; (ii) count for each cluster; and/or (iii) cluster variance in all dimensions.

Processing proceeds to operation S404 where, the top N most important dimensions are selected, through one or more statistical methods, for example an F-test. With regard to the top N most important dimensions, the number N is determined in accordance with the data under analysis and the goals of the analysis. N may be any number inclusively between 1 and the total number of dimensions in the data.

Processing proceeds to operation S406 where cut points (also referred to as cluster boundaries) are computed for each dimension.

Processing proceeds to operation S408 where rules for each cluster are generated. Further, clusters are described as profiles which are formed by some intervals of dimension instead of cluster centers.

Some embodiments of the present invention may include one, or more, of the following features, characteristics and/or advantages: (i) generates rules based on cluster statistics rather than original data; (ii) avoids cluster overlap; (iii) reduces dimensions of the data; (iv) outputs clusters with interval rules of top N most important dimensions; and/or (v) outputs clusters with interval rules in a few dimensions.

Some embodiments of the present invention implement a new clustering method that outputs clusters with some interval rules of a few dimensions. The method includes the following operations: (i) data clusters are determined based on conventional clustering method(s) such as k-mean and two-step method; (ii) select the top N most important dimensions supervised by the clusters that are determined in operation (i) above; (iii) determine cut points (cluster boundaries) on each dimension where each cut point is an interval-based rule that splits some clusters along the dimension; (iv) rules for each cluster are obtained by combining rules that split off the cluster from other clusters; and (v) final clusters are obtained based on the rules of each cluster.

The cut points in operation (iii) in the paragraph above are computed based on basic statistics that output from step (ii) above. The basic statistics include: (i) cluster size (the number of records in the cluster); (ii) cluster center (mean of each dimension in the cluster); (iii) and cluster variance (variance of each dimension in the cluster).

Some embodiments of the present invention may include one, or more, of the following features, characteristics and/or advantages: (i) generates rule-based profiles based on a few dimensions for clusters so that a user can easily understand cluster characteristics; (ii) the rule-based profiles enable the user quickly to determine to which cluster a new data point belongs; (iii) rule-based profiles are simple intervals.

Some embodiments of the present invention create a system for generating high dimensional cluster profiles including: (i) generating cluster profiles based on basic statistics without additional data passes; (ii) generating cluster profiles in a few important dimensions; (iii) and/or cluster profiles are described as intervals.

Some embodiments of the present invention employ a method as follows: (i) reduce dimensions by a supervised method in which cluster labels are regarded as target values; (ii) define the overlap strength of two clusters along with a dimension; (iii) find an optimal cut point (cluster boundary) which separates clusters; and (iv) generate cluster profiles.

In some embodiments of the present invention, the process includes the following operations: (i) collect basic statistics from each cluster, including cluster centers (means) and cluster variances, in all dimensions; (ii) select the top N most important dimensions supervised by the clusters where N is an arbitrary number appropriate to a given analysis; (iii) determine cut points (cluster boundaries) for each dimension; (iv) generate a profile for each cluster; and describe clusters as rules which are formed by some dimension intervals instead of cluster centers.

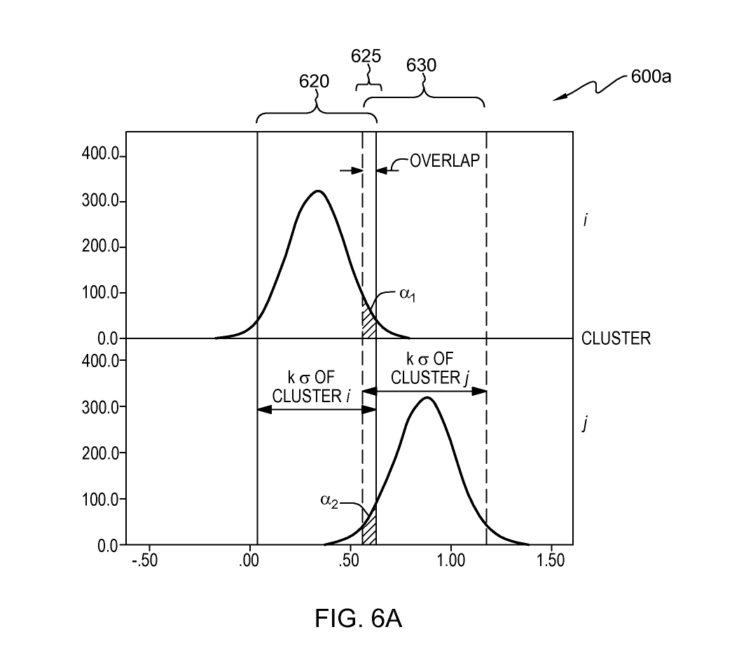

Flowchart 500a of FIG. 5A includes the following operations (with process flow among and between the operations as shown by arrows in FIGS. 5a): S502, S504, S506, S508, S510, and S512.

Screenshot view 500b of FIG. 5B shows a scatter plot of two clusters (cluster 1 and cluster 2) graphed against two dimensions (x1 on the horizontal axis, and x2 on the vertical axis) in some embodiments of the present invention. Interval 520 is a 26 interval of cluster 1, in dimension x1, centered about the cluster 1 mean (where σ is the cluster standard deviation, or sample standard deviation) as commonly understood in the field of statistics. Interval 530 is a 2σ interval of cluster 2, in dimension x1, centered about the cluster 2 mean. Overlap 525 is a region, in dimension x1, where intervals 520 and 530 overlap. Centroid 521 is the central value (also referred to as the cluster mean, or as μ1) of cluster 1. Centroid 531 is the central value (also referred to as the cluster mean, or as μ2) of cluster 2.

Note: Intervals and standard deviation are computed for each dimension of interest, not only the x1 dimension, as illustrated in the paragraph above, but in the x2 dimension as well. In some embodiments of the present invention, there are many dimensions and standard deviations and intervals are computed for each dimension. Further note: The intervals (2σ) are of arbitrary width for illustration only. In some embodiments, the intervals can be kσ, where k is any value as applicable to a given analysis.

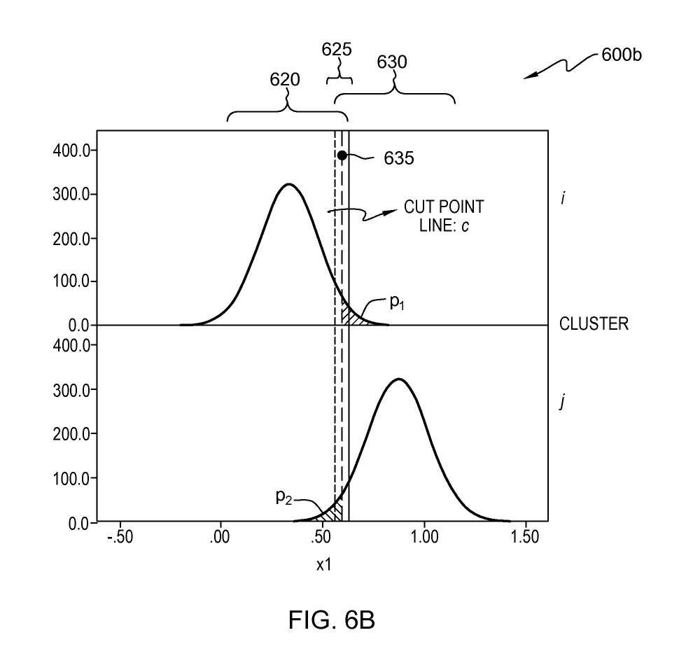

As shown in FIGS. 6A and 6B, graphs 600a and 600b are probability distributions of clusters i and j, in a first dimension, in some embodiments of the present invention. Interval 620 is a kσ interval, associated with cluster i. Interval 630 is a kσ interval, associated with cluster j, where k is an arbitrary number, and σ is the standard deviation (or sample standard deviation) of data in the associated cluster. Overlap 625 is a region, in the first dimension, where intervals 620 and 630 overlap.

In some embodiments of the present invention,

S=max(α, α2), where:

S is the overlap strength of adjacent intervals;

α1 is the probability of data in cluster i in overlap 625; and

α2 is the probability of data in cluster j in overlap 625.

In some embodiments of the present invention, intervals are separable intervals if

S≦α

where α is an arbitrary number, for example 0.05.

If S is less than or equal to α, then adjacent intervals can be separated.

As shown in FIG. 600b, cut point 635 between clusters i and j (the boundary between clusters i and j) is optimized by splitting the two clusters in such a way that both clusters have the same probability of error that some points are split incorrectly, that is:

p1=p2

where:

p1 is the probability that a point in cluster i is mistakenly assigned to cluster j; and

p2 is the probability that a point in cluster j is mistakenly assigned to cluster i.

In some embodiments of the present invention, the rules based on cut point are:
If X1≦c, then X1 belongs to cluster i; and
If X1>c, then X1 belongs to cluster j.

where:

X1 represents the value (in dimension x1) for an arbitrary data point; and

c is cut point 635.

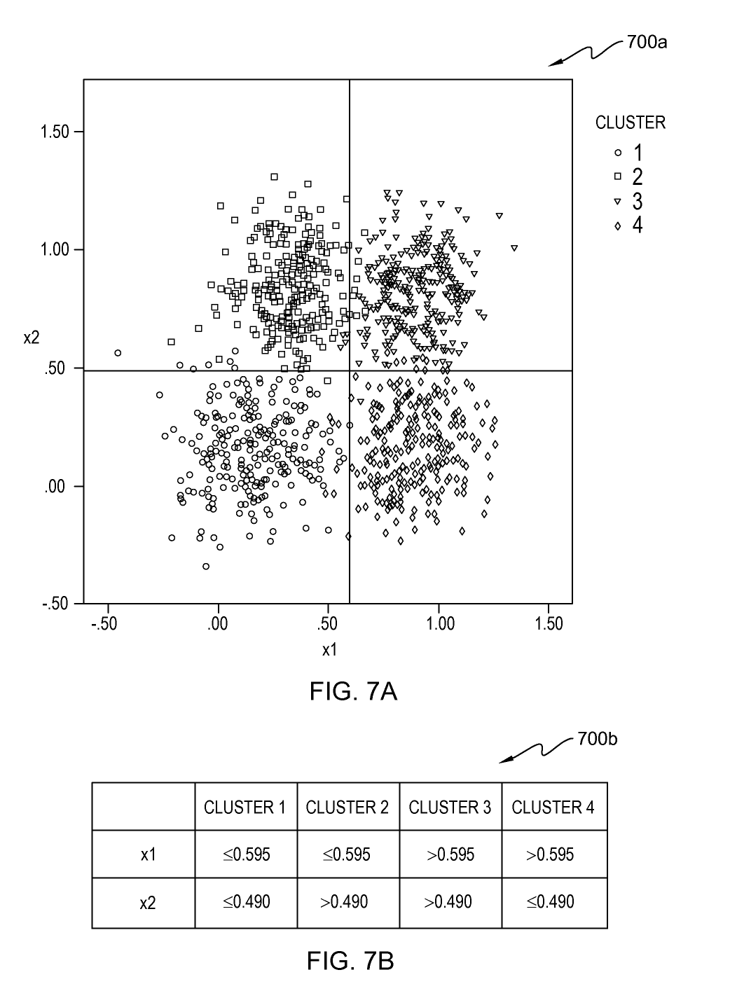

As shown in graph 700a of FIG. 7A, in some embodiments of the present invention, cluster profiles are created by merging rules from each dimension. Cluster profiles are represented as intervals of a few dimensions. For example, as shown in table 700b of FIG. 7B, cluster 1 is in a region that is less than or equal to 0.595 in dimension x1, and less than or equal to 0.490 in dimension X2, whereas cluster 2 is in a region that is less than or equal to 0.595 in dimension x1 and greater than 0.490 in dimension x2.

Some embodiments of the present invention may include one, or more, of the following features, characteristics and/or advantages: (i) automatically computes cut points on key dimensions and generates cluster profiles for better user understanding of cluster characteristics; (ii) requires limited statistics rather than raw data; and/or (iii) works with various conventional clustering techniques.

Some embodiments of the present invention may include one, or more, of the following features, characteristics and/or advantages: (i) requires only limited statistics from the clusters; (ii) works with conventional clustering algorithms; and/or (iii) provides rules that are less complex as compared to conventional methods.

Some embodiments of the present are applicable to various fields including: (i) market research when working with multivariate data from surveys and test panels; and/or (ii) other scenarios where the cluster analysis is needed.

Some embodiments of the present invention: (i) provide cut points based on predictors; (ii) use predictor(s) to characterize clusters; and/or (iii) improve user insights into the cluster profiling.

Some embodiments of the present invention output clusters with some interval rules of a few dimensions. The method includes the following operations: (i) data clustering is based on conventional clustering methods such as k-mean and two-step method; (ii) the top N most important dimensions supervised by the clusters (as determined by conventional clustering methods) are selected; (iii) cut points are determined on each dimension, where each cut point is an interval-based rule that can split some clusters along the dimension; (iv) rules for each cluster are determined by combining the rules that can split a cluster from other clusters; and (v) final clusters are obtained based on the rules of each cluster.

A method of some embodiments of the present invention includes the following operations: (i) data is clustered based on conventional clustering method(s) such as k-mean and two-step method and each resultant cluster is characterized by a set of basic statistics; (ii) top N most important dimensions are selected, based on F-test by treating cluster labels as values of a pseudo target; (iii) optimal cut points are determined on each dimension where a cut point is an interval-based rule that can split two clusters along the dimension with minimum probability of error that points are split incorrectly; (iv) rules for each cluster are obtained by combining the rules that can split a cluster from other clusters; and (v) final clusters are determined based on the rules of each cluster.

Further with respect to item (iii) in the paragraph above, the cut points are computed based on the basic statistics that are outputs from item (i). These basic statistics include: (a) cluster size (number of records in the cluster); (b) cluster center (statistical mean along each dimension in the cluster); and/or (c) cluster variance and/or standard deviation along each dimension in the cluster).

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

User/subscriber: includes, but is not necessarily limited to, the following: (i) a single individual human; (ii) an artificial intelligence entity with sufficient intelligence to act as a user or subscriber; and/or (iii) a group of related users or subscribers.

Receive/provide/send/input/output/report: unless otherwise explicitly specified, these words should not be taken to imply: (i) any particular degree of directness with respect to the relationship between their objects and subjects; and/or (ii) absence of intermediate components, actions and/or things interposed between their objects and subjects.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Every pair-wise definable pair: every unique pair of items that can be defined from a set of items (such as a set of initial clusters); for example, if a set of clusters is made up of clusters A, B and C, then every pair-wise definable pair is: (i) pair AB, (ii) Pair AC, and (iii) pair BC.

1. A computer-implemented method comprising:
receiving, by a computer, a set of data items, where each data item is characterized by a set of scalar values respectively corresponding to a plurality of dimensions;
determining, by a computer, a set of initial clusters that divide the set of data items into a plurality of initial clusters including a first initial cluster and a second initial cluster;
determining, by a computer, a first distribution curve, with respect to the first dimension, for the scalar values corresponding to the first dimension of the data items of the first initial cluster;
determining, by a computer, a second distribution curve, with respect to the first dimension, for the scalar values corresponding to the first dimension of the data items of the second initial cluster;
determining, by a computer, a first-dimension-first-cluster-second-cluster cut-off value such that the following two proportions are at least substantially equal: (i) a proportion of the area under the first distribution curve and below the first-dimension-first-cluster-second-cluster cut-off value to the total area under the first distribution curve, and (ii) a proportion of the area under the second distribution curve and above the first-dimension-first-cluster-second-cluster cut-off value to the total area under the second distribution curve; and
defining, by a computer, a plurality of new clusters of the data items, which are respectively characterized by a set of scalar values respectively corresponding to the plurality of dimensions, based in part upon the first-dimension-first-cluster-second-cluster cut-off value
wherein the method is directed to an improvement with respect to use of the computer as a tool to more accurately define clusters of data items.

2-3. (canceled)

4. The computer-implemented method of claim 1 further comprising:
for each dimension i of the plurality of dimensions, determining a plurality of cut-off values for each dimension, with the determination including the following:
for every successive pair of initial clusters as determined by mean values for the scalar values corresponding to dimension i of each initial cluster, with each successive pair of initial clusters including an initial cluster A and an initial cluster B for purposes of performing the following actions:
determining an initial cluster A distribution curve, with respect to the dimension i, for the data items of the initial cluster A,
determining an initial cluster B distribution curve, with respect to the dimension i, for the data items of the initial cluster B, and
determining a dimension-i-cluster-A-cluster-B cut-off value such that the following two proportions are at least substantially equal: (i) a proportion of the area under the initial cluster A distribution curve and below the dimension-i-cluster-A-cluster-B cut-off value to the total area under the initial cluster A distribution curve, and (ii) a proportion of the area under the second distribution curve and above the dimension-i-cluster-A-cluster-B cut-off value to the total area under the initial cluster B distribution curve.

5. The computer-implemented method of claim 4 further comprising:
defining a plurality of new clusters of the data items, which are respectively characterized by a set of scalar values respectively corresponding to the plurality of dimensions, based upon at least some of the plurality of dimension-i-cluster-A-cluster-B cut-off values.

6. (canceled)

7-18. (canceled)

19-24. (canceled)

25. A computer-implemented method comprising:
receiving, by a computer, a set of multi-dimensional data items, where each multi-dimensional data item is characterized by a set of scalar values respectively corresponding to a set of dimension(s) including a first dimension;
receiving, by a computer, an identification of a set of multi-dimensional initial clusters that divide the set of data items into a plurality of initial clusters including a first initial multi-dimensional cluster and a second initial multi-dimensional cluster;
determining, by a computer, a first distribution curve, with respect to the first dimension, for the scalar values corresponding to the first dimension of the data items of the first initial multi-dimensional cluster;
determining, by a computer, a second distribution curve, with respect to the first dimension, for the scalar values corresponding to the first dimension of the data items of the second initial multi-dimensional cluster; and
determining, by a computer, a first-dimension-first-cluster-second-cluster cut-off value such that the following two proportions are at least substantially equal: (i) a proportion of the area under the first distribution curve and below the first-dimension-first-cluster-second-cluster cut-off value to the total area under the first distribution curve, and (ii) a proportion of the area under the second distribution curve and above the first-dimension-first-cluster-second-cluster cut-off value to the total area under the second distribution curve;
defining, by a computer, a plurality of new multi-dimensional clusters based in part upon the first-dimension-first-cluster-second-cluster cut-off value; and
extracting, by a computer, an insight as to a first relationship between data of multiple dimensions of the plurality of dimensions based upon the definition of the plurality of new multi-dimensional clusters;
wherein the method is directed to an improvement with respect to use of the computer as a tool to more accurately define clusters of data items.

26-27. (canceled)

28. The computer-implemented method of claim 25 further comprising performance as post-processing and insight extraction operations the following:
for each dimension i of the plurality of dimensions, determining a plurality of cut-off values for each dimension, with the determination including the following:
for every successive pair of initial clusters as determined by mean values for the scalar values corresponding to dimension i of each initial cluster, with each successive pair of initial multi-dimensional clusters including an initial cluster A and an initial cluster B for purposes of performing the following actions:
determining an initial cluster A distribution curve, with respect to the dimension i, for the data items of the initial cluster A,
determining an initial cluster B distribution curve, with respect to the dimension i, for the data items of the initial cluster B, and
determining a dimension-i-cluster-A-cluster-B cut-off value such that the following two proportions are at least substantially equal: (i) a proportion of the area under the initial cluster A distribution curve and below the dimension-i-cluster-A-cluster-B cut-off value to the total area under the initial cluster A distribution curve, and (ii) a proportion of the area under the second distribution curve and above the dimension-i-cluster-A-cluster-B cut-off value to the total area under the initial cluster B distribution curve.

29. (canceled)

30. The computer-implemented method of claim 25 wherein:
the first distribution curve is a bell curve distribution characterized by a standard deviation of the first initial cluster with respect to the first dimension; and
the second distribution curve is a bell curve distribution characterized by a standard deviation of the second initial cluster with respect to the first dimension.
